(19) United States
(12) Patent Application Publication
(10) Pub. No.: US 2025/0211725 A1
(43) Pub. Date: Jun. 26, 2025

(54) Tactical Goggles with Multi-Sensor System for Enhanced Visualization

(71) Applicant: Arnold Adamczyk, Pelplin (PL)

(72) Inventor: Arnold Adamczyk, Pelplin (PL)

(21) Appl. No.: 19/077,192

(22) Filed: Mar. 12, 2025

(51) Int. Cl. H04N 13/344; A42B 1/247; G01S 13/88; G01S 15/89; G01S 17/08; G02B 27/01; H04N 13/25; H04N 23/11

(52) U.S. Cl. CPC H04N 13/344; G01S 13/885; G01S 15/89; G01S 17/08; G02B 27/0176; H04N 13/25; H04N 23/11; A42B 1/247

(57) ABSTRACT

The invention relates to multi-sensor tactical augmented visualization goggles designed for protective and ballistic helmets. The goggles integrate thermal imaging, night vision, and augmented reality visualization via transparent waveguide displays. Unlike traditional systems with embedded processing, this invention separates data processing into an external computing module. Sensor data is transmitted in real-time to AI-powered SensorFusion systems, which handle data fusion and AR overlay generation. The open-platform design allows third-party providers to develop computing modules and software, fostering innovation. The system features an impact-resistant protective shield, interchangeable mounting options, and high-speed data connectivity. Its ergonomic construction ensures a stable fit, minimizing movement. Passive operation supports stealth missions by preventing detectable emissions. By offloading computation, the goggles remain lightweight while offering advanced visualization for military, law enforcement, emergency response, and industrial applications.

### PRIOR ART

In the field of existing technical knowledge, a relevant prior patent related to similar application areas is U.S. Pat. No. 10,642,038B1. This patent explicitly defines the processing and visualization of data, specifying the image processing path, analytical methods, and the presentation of information on waveguide displays. The system integrates both sensors and computational mechanisms responsible for data fusion and visualization, forming a closed architecture with predefined functionalities.

In contrast, the proposed solution fundamentally differs by not defining any data processing or visualization methods. Unlike U.S. Pat. No. 10,642,038B1:
Data processing, analysis, and fusion are not part of the invention—the system solely provides an integrated, standardized sensory and display platform, while all computational tasks are performed by external computing units.
It does not include a “video processing circuit with symbol generator”, which are explicitly claimed in U.S. Pat. No. 10,642,038B1. Instead, the proposed system relies on an open interface for external computing modules, allowing for flexible and scalable processing solutions without embedding any proprietary image processing hardware.
It features a bidirectional high-speed communication interface based on the USB standard, ensuring compatibility with various external computing modules and offering adaptability across different computational platforms.

Furthermore, no existing open sensory-display platforms are specifically designed to establish a standardized sensory architecture for environmental data capture and image-based information visualization, while simultaneously opening the field for third-party providers of mobile computing systems and application developers. This innovation allows for the creation of military, engineering, emergency response, and other specialized applications, where adaptability and interoperability with various computational solutions are critical.

The proposed solution can be seen as an open platform offering observation and information display functionalities for developers of dedicated processing modules, similar to how a smartphone allows for the integration of dedicated applications. This distinguishes the invention from previously patented solutions, which were closed systems, much like a non-smart mobile phone that lacks the flexibility of third-party software development.

Moreover, the open and standardized architecture of this system will enable broader engagement of specialists from various fields, fostering interdisciplinary collaboration. By providing a flexible and extensible hardware framework, this approach will stimulate the development of new image processing technologies and advanced augmented visualization synthesis methods, leading to continuous innovation in military, engineering, and other professional applications.

This architecture does not fall under the scope of U.S. Pat. No. 10,642,038B1, as the invention does not encompass image processing methods, a video processing circuit, or a symbol generator but rather introduces a universal sensory and display platform, designed to be compatible with multiple computing units and external data processing solutions.

### BACKGROUND OF THE INVENTION

Current night vision and augmented visualization systems designed for tactical and emergency applications exhibit several operational limitations. Traditional binocular night vision goggles typically have limited sensor integration, relying primarily on visible light amplification or basic thermal imaging technologies. These limitations result in reduced situational awareness, a narrow field of view, increased weight, and user discomfort.

More advanced augmented visualization systems integrate multiple sensors and augmented reality (AR) functions but often rely on separate, independently mounted components, such as displays, batteries and sensor assemblies, requiring individual placement and cabling on the user's helmet. This fragmented setup leads to increased system complexity, extended deployment and removal times, reduced mobility, and diminished user comfort and efficiency. Additionally, the lack of standardization in sensor configurations results in inconsistent data fusion quality and integration difficulties.

To address these challenges, the proposed system introduces a standardized multi-sensor architecture with an integrated configuration of five cameras, a rangefinder, a gyroscope, a magnetometer, GPS, and other essential components. By consolidating these key elements into a single unit, the system ensures consistent sensor alignment and data fusion while maintaining an open interface for external computing modules. This design reduces the complexity associated with separate sensor placements and optimizes operational efficiency.

Furthermore, many existing systems lack adaptability due to fixed protective covers that do not allow for rapid adjustment or replacement in response to changing operational conditions or damage. The proposed solution supports interchangeable protective components, enabling users to modify shielding and display optics as needed.

Another major limitation of current solutions is that the process of transforming sensor data into a visualized display output is predefined by closed algorithms embedded in proprietary hardware modules. These fixed, hardware-encoded algorithms dictate how sensor data is fused, processed, and presented to the user. In many cases, these proprietary image processing solutions are subject to patent protection, further restricting third-party developers from adapting or improving system performance. In contrast, the proposed solution eliminates such hardware dependent processing elements, allowing external computing units to take full control over data fusion and visualization techniques.

Another critical issue in current solutions is the widespread practice of mounting computing modules directly on the user's helmet. This design leads to significant heat generation, causing thermal discomfort for the user, increasing the risk of system overheating, and negatively impacting user comfort, component reliability, and overall system durability. Additionally, this heat emission increases the user's thermal visibility, making them more susceptible to detection in combat scenarios.

Additionally, many operational scenarios require strict passive mode functionality, meaning that the systems must operate without emitting detectable radio signals, laser signals (including SLAM), thermal signatures, or visible and infrared light emissions to ensure stealth and operational security. Current augmented visualization systems generally do not fully support such passive modes.

An additional major limitation of contemporary systems is their fragmentation. Users often rely on multiple separate devices, such as night vision goggles, thermal cameras, laser rangefinders, LIDAR systems, augmented reality modules, and independent computing processors. Each of these devices requires separate power sources, and the use of batteries with different standards increases the weight and bulk of the entire equipment set while also complicating its operation and maintenance. The complexity of these systems leads to higher failure rates and frequent battery management, which can cause significant operational difficulties. Consequently, users are forced to carry additional equipment, which not only increases physical burden but also restricts movement and impairs mission effectiveness.

Another fundamental issue with existing systems is their closed and proprietary nature, where integrated computing modules dictate both hardware and software functionalities, restricting third-party innovation. Many currently available solutions utilize fixed, embedded video processing circuits and symbol generators, which confine their capabilities to predefined functionalities and prevent external developers from introducing new data fusion algorithms, visualization methods, or mission-specific optimizations.

Therefore, there is a clear and unmet need to develop an integrated, open-platform augmented reality (AR) system that overcomes these limitations by:
consolidating various sensor technologies into a single compact housing,
reducing structural complexity and cabling requirements,
eliminating proprietary video processing circuits and symbol generators, allowing for external computing modules to handle data fusion,
providing an open and standardized high-speed communication interface, enabling compatibility with a wide range of third-party computing units,
decoupling processing functions from hardware, allowing developers to create specialized software applications tailored for military, engineering, and emergency response applications,
ensuring efficient operation in passive mode,
optimizing heat management by relocating computing modules away from the helmet,
allowing for rapid system adaptation to different operational conditions,
standardizing power supply and eliminating the need for multiple separate batteries,
reducing the weight and bulk of the equipment, thereby increasing user mobility and enhancing mission performance.

By shifting the focus from a proprietary closed system to an open, modular platform, the proposed solution fosters a more dynamic ecosystem where third-party developers and manufacturers can contribute new computational modules, AI-driven data fusion solutions, and real-time augmented visualization enhancements. This is analogous to the evolution of smartphones, which transitioned from closed, single-purpose communication devices to open platforms supporting diverse applications and external integrations.

The proposed solution significantly improves user comfort, operational efficiency, and equipment reliability, while also stimulating technological advancement through industry-wide collaboration. By establishing a universal sensory-display architecture, it creates new opportunities for innovation in tactical, emergency, and industrial applications.

### SUMMARY OF THE INVENTION

The invention relates to tactical augmented visualization goggles comprising a compact housing (1), as illustrated in FIGS. 1-3, designed for mounting on standard protective helmets or ballistic helmets using a standardized connector (2). The housing integrates a standardized multi-sensor configuration, stereoscopic imaging cameras, transparent waveguide displays, and interface circuit boards that enable data transmission between the goggles and an external computing unit.

The invention employs an innovative multi-camera configuration, which includes:
dual thermal imaging cameras (3, 4) for heat detection,
dual night vision cameras (5, 6), also capable of daytime operation,
a centrally positioned wide-angle AR camera (7), as shown in FIG. 1, designed for detecting augmented reality markers and enhancing situational awareness.

The dual-camera systems (3, 4 and 5, 6) provide stereoscopic vision, which is crucial for accurately perceiving distances, shapes, and object sizes, significantly improving the user's spatial awareness. By establishing a standardized layout of five cameras and essential sensors, the invention ensures consistent data fusion performance and reliable environmental perception.

Additionally, the goggles are equipped with an integrated laser rangefinder or LIDAR sensor (8), supported by an infrared emitter (9), which significantly enhances visibility in low-light conditions. Other onboard sensors include a gyroscope, magnetometer, and GPS module, all contributing to precise spatial orientation and dynamic tracking capabilities.

Unlike previous solutions, which often incorporate fixed, embedded computing modules, this invention is designed as an open-platform system with a dedicated high-speed data interface that allows external computing units to handle all data processing and augmented visualization. This ensures greater flexibility by enabling compatibility with third-party computing solutions, including high-performance processing platforms with multi-core GPUs optimized for AI-driven sensor fusion algorithms and various operating systems.

The processed information is displayed as augmented reality overlays on transparent waveguide displays (10, 11), providing real-time operational insights and mission-critical data visualization.

The goggles also feature a removable protective shield (12), illustrated in FIG. 5, which can be quickly replaced and hermetically installed using mounting screws (14, 15). Additionally, a dual-layer protection system has been implemented, consisting of a front protective shield (13) and a rear cover (17), providing comprehensive protection for both the device and the user.

The goggle housing includes a durable, waterproof wired interface connector (16), enabling a secure connection to an external miniature computing module. This module, which features a replaceable battery, is responsible for SensorFusion data processing and advanced visualization functions. By allowing the external computing unit to be carried in thermally insulated pockets or backpacks, the system effectively prevents thermal discomfort, component overheating, and excessive thermal visibility in combat scenarios.

It should be noted that the external computing module is a separate component and does not form part of this invention. Instead, the invention defines a universal sensory-display platform designed to work with a variety of external processing solutions, fostering innovation and interoperability in tactical, engineering, and emergency response applications.

### BRIEF DESCRIPTION OF DRAWINGS

FIG. 1 is a front view of the goggles, illustrating the arrangement of dual thermal cameras (3, 4), dual night/day cameras (5, 6), central AR camera (7), protective housing (1), port for a standardized helmet connector (2), laser rangefinder (8), infrared illumination emitter (9), transparent waveguide displays (10, 11), removable protective shield module (12), front ballistic shield (13), protective shield module mounting screws (14, 15), and waterproof signal-power connector (16).

FIG. 2 is a top view illustrating the compact goggles housing (1), standardized helmet connector (2), removable protective shield module (12), front ballistic shield (13), and mounting screws for the protective module (14).

FIG. 3 is a side view showing the compact goggles housing (1), standardized helmet connector (2), removable protective shield module (12), waterproof signal-power connector (16), and a specifically designed curved recess (18) for secure and ergonomic helmet attachment.

FIG. 4 is a perspective view from the user's side, illustrating the housing (1), standardized helmet connector (2), transparent waveguide displays (10, 11), removable protective shield module (12), waterproof connector (16), internal ballistic shield (17), and helmet contour recess (18).

FIG. 5 is a front perspective view illustrating housing (1), standardized helmet connector (2), transparent waveguide displays (10, 11), removable protective shield module (12), front ballistic shield (13), protective shield mounting screws (14, 15), waterproof connector (16), internal ballistic shield (17), and provides a detailed view of how the removable protective shield module (12) is securely attached using screws (14, 15).

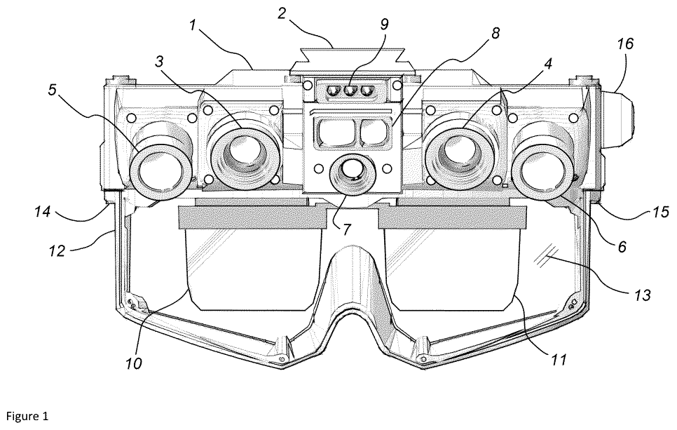

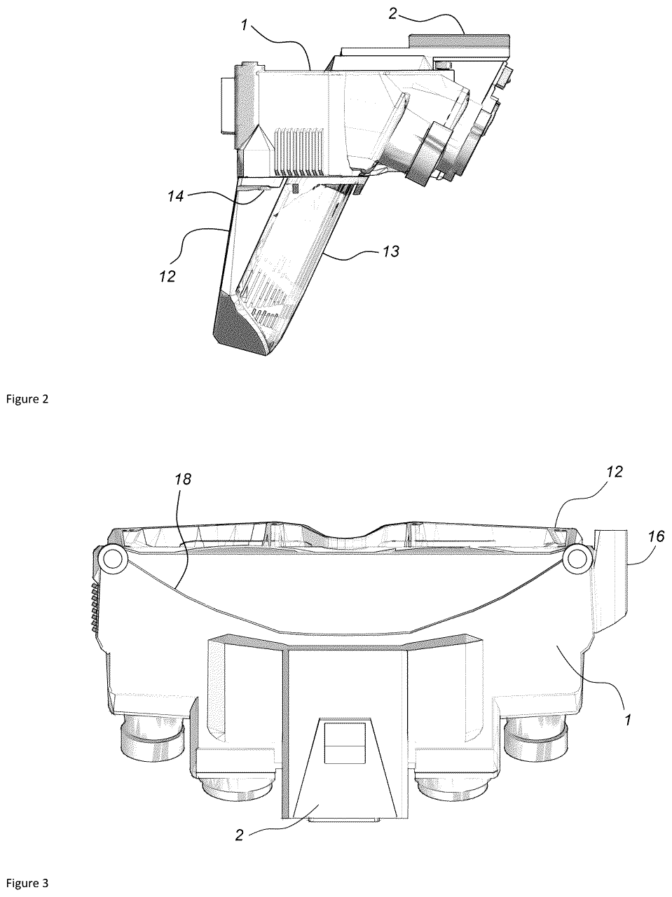

### DETAILED DESCRIPTION OF THE INVENTION

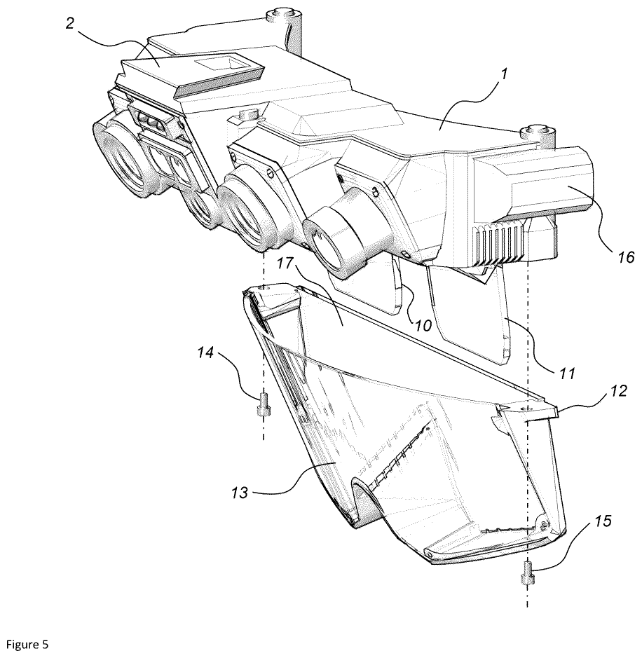

The AR goggles feature a durable and lightweight housing (1), constructed from high-strength materials specifically chosen for demanding operational environments. The housing is securely mounted to standard protective or ballistic helmets using a universal mounting system, compatible with standard helmet mounts such as the Wilcox G24. The mounting interface (2), illustrated in FIG. 4, enables secure and quick attachment and detachment of the goggles for various operational applications.

### Integrated Components:

Within the housing, the following components are integrated to form a fully standardized multi-sensor system, ensuring structured data acquisition and real-time environmental monitoring:
Dual thermal imaging cameras (3, 4), optimized for detecting heat signatures in low-visibility conditions or situations where thermal imaging is crucial for identifying concealed objects.
Dual night vision cameras with daytime operation capability (5, 6), ensuring operational flexibility across a wide range of lighting conditions.
A centrally positioned wide-angle AR camera (7), designed for continuous environmental monitoring, enhanced situational awareness, and augmented reality (AR) functionalities such as marker detection and object tracking.
A laser rangefinder or an optional LIDAR sensor (8), providing real-time precise distance measurement and detailed three-dimensional scanning of the surroundings to support accurate spatial mapping for integrated visualization.
An infrared emitter (9), which enhances the night vision capabilities of the goggles, particularly in total darkness or minimally lit environments.
Additional sensors, including a gyroscope, magnetometer, and GPS module, which contribute to precise spatial orientation and tracking.

### Data Processing & Augmented Reality Visualization:

The device functions as an integrated sensory and visualization platform, capturing real-time environmental data and transmitting it to external computing systems for processing. Built-in electronic interface modules facilitate fast and reliable data exchange with external computing units, which process sensor data using advanced SensorFusion algorithms and AI-based analysis. Sensor Fusion capabilities are not inherently embedded within the device but are instead provided as one of many possible computational functions by external hardware modules and software applications that can be installed and configured on demand. These overlays are then displayed on transparent waveguide displays (10, 11), significantly enhancing situational awareness, operational effectiveness, and safety in demanding environments.

### Protective Shield & Modular Construction:

The goggles are equipped with a removable protective shield module (12), which is impact-resistant, hermetically sealed, and easily replaceable via mounting screws (14, 15). The modular design allows for rapid shield replacement or adjustment in dynamic operational conditions.

Additionally, dual-layer ballistic protection is provided, consisting of a front ballistic shield (13) and an inner ballistic shield (17), ensuring high durability and comprehensive protection for both the device and the user's eyes and face.

### Power & Data Connectivity:

The housing includes a rugged, waterproof power and data transmission connector (16), designed for seamless integration with an external miniature computing module powered by replaceable batteries. This external computing unit handles all computational tasks, offloading SensorFusion data processing and advanced visualization functions from the goggles themselves. By relocating processing tasks to thermally insulated pockets, tactical belt holsters, or backpacks, the system prevents thermal discomfort, overheating, and excessive thermal visibility in combat scenarios.

### Ergonomic Helmet Integration:

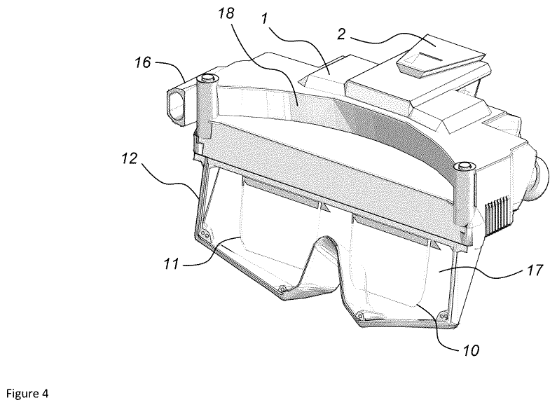

To ensure maximum stability and ergonomics, the goggle housing is contoured for a secure fit against the front edge of the helmet. The design includes a rounded recess (18), as illustrated in FIGS. 3 and 4, allowing stable alignment of the goggles with the helmet's surface, minimizing movement during use. This enhances user comfort and mounting security, eliminating unnecessary gaps and potential vibrations during dynamic operations.

### Universal Computing Interface:

To maximize compatibility with various external computing units, particularly high-performance miniature computers supporting AI-accelerated processing with multi-core GPUs, the system utilizes a standard USB communication interface with DisplayPort Alternate Mode (DP Alt Mode) support. Additionally, D+ and D− lines have been allocated for sensor control and management, allowing independent communication with the computing unit.

The use of widely adopted communication standards ensures full signal compatibility with most available miniature computers equipped with sufficient CPU and GPU processing power. This allows for efficient sensor data processing, execution of SensorFusion algorithms, and generation of advanced augmented reality (AR) visualizations without requiring custom or proprietary hardware solutions.

### High-Speed Data Transmission & Power Delivery:

The USB 3.2 Gen 2 standard guarantees high data transmission bandwidth, enabling direct transfer of video streams, sensor data, and real-time device control. The support for DisplayPort Alternate Mode allows video output to be directly transmitted to the goggles, eliminating the need for additional cables and interfaces.

This architecture enables bidirectional data transfer and simultaneous power delivery using a single standard, replaceable, thin-diameter cable, significantly simplifying system integration and enhancing ergonomics. Reducing the number of cables and using a thin, flexible wire improves user comfort, minimizes the risk of entanglement with equipment, and enhances mobility in operational conditions.

### Modular & Mission-Adaptive Design:

This solution provides users with flexibility in selecting external computing units, allowing adaptation to mission requirements, operational needs, and available hardware resources. The modularity of the system enhances its versatility across a wide range of tactical, rescue, and industrial applications by supporting external high-performance computing units capable of advanced AI processing and real-time visualization.

### EXAMPLES OF APPLICATIONS

The invention is designed for a wide range of tactical, industrial, and emergency applications, significantly enhancing situational awareness, operational efficiency, and personnel safety in various demanding environments. Below are some of the key application areas:
Military and Law Enforcement Operations:
   i. Enhanced night vision and thermal imaging for reconnaissance and surveillance.
   ii. Real-time augmented reality overlays for navigation, target identification, and threat detection.
   iii. Secure communication with external computing units for mission coordination and data sharing.
   iv. Passive operation mode to ensure stealth in covert missions.
Emergency Response and Search & Rescue:
   i. Improved visibility in smoke, fog, or darkness for firefighting operations.
   ii. Real-time hazard detection and mapping in disaster-stricken areas.
   iii. Integration with external data sources for coordinated search and rescue missions.
Industrial and Hazardous Environments:
   i. Augmented visualization for workers in low-light conditions or confined spaces.
   ii. Enhanced safety monitoring in hazardous industrial zones, such as chemical plants and mining operations.
   iii. Thermal imaging for preventive maintenance and fault detection in electrical and mechanical systems.
Medical and Tactical Emergency Services:
   i. Assisting paramedics and field medics with real-time biometric data overlays.
   ii. Thermal imaging to detect body heat signatures and injuries in mass casualty incidents.
   iii. Hands-free access to medical protocols and critical data for rapid decision-making.

The versatility and modularity of the system make it adaptable to a wide range of specialized applications, ensuring that users in different fields can benefit from its advanced visualization, real-time data integration, and enhanced environmental perception.

1. Multi-sensor tactical augmented visualization goggles, comprising:
a compact housing adapted for mounting on protective helmets and ballistic helmets using a standard connector;
an integrated sensor array positioned directly within the compact housing, including two thermal imaging cameras configured for stereoscopic thermal imaging, two night vision cameras configured for stereoscopic imaging in low-light conditions and daylight, and a centrally positioned wide-angle general-purpose camera;
two transparent waveguide displays housed within the compact structure, presenting stereoscopic augmented reality overlays derived from sensor data fusion;
a removable, hermetically sealed, impact-resistant protective module secured with detachable screws;
a high-speed communication interface configured to transmit sensor data to an external computing system for processing, wherein the goggles lack an integrated video processing circuit with a symbol generator, ensuring that all computational tasks, including sensor fusion and augmented reality rendering, are executed externally.

2. The goggles of claim 1, wherein the removable protective module is replaceable using an alternative mounting mechanism, including clips, magnetic fasteners, or another quick-release mechanism.

3. The goggles of claim 1, further comprising an integrated laser rangefinder.

4. The goggles of claim 1, further comprising a LIDAR system.

5. The goggles of claim 1, further comprising an integrated short-range ground-penetrating radar for subsurface structure visualization.

6. The goggles of claim 1, further comprising a stereoscopic sonar for spatial visualization.

7. The goggles of claim 1, characterized by a rear recess shaped to provide stable fitting to protective and ballistic helmets, thereby enhancing ergonomic stability and user comfort.
